(19) United States
(12) Patent Application Publication
(10) Pub. No.: US 2009/0285259 A1
(43) Pub. Date: Nov. 19, 2009

(54) SYSTEM AND METHOD FOR THERMAL INSPECTION OF OBJECTS

(75) Inventors: Jason Randolph Allen, Niskayuna, NY (US); Nirm Velumylum Nirmalan, Niskayuna, NY (US); Mohamed Sakami, Clifton Park, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, SCHENECTADY, NY (US)

(21) Appl. No.: 12/120,617

(22) Filed: May 14, 2008

(51) Int. Cl. G01J 5/08

(52) U.S. Cl. 374/130; 374/E11.001

(57) ABSTRACT

A thermal measurement system for an object is provided. The system includes an array of detectors in two dimensions configured to receive radiation within multiple wavelength ranges, the array of detectors having a first axis representing a spatial dimension and a second axis representing a wavelength dimension. The system also includes an optical system configured to focus the radiation emitted by the object on to the array of detectors.

### BACKGROUND

The invention relates generally to thermal inspection systems and methods and more specifically, to non-destructive thermal inspection of cooled parts during operation of the system.

A gas turbine engine includes a compressor that provides pressurized air to a combustion section where the pressurized air is mixed with fuel and burned for generating hot combustion gases. These gases flow downstream to a multi-stage turbine. Each turbine stage includes a plurality of circumferentially spaced apart blades extending radially outwardly from a wheel that is fastened to a shaft for rotation about the centerline axis of the engine. The hot gases expand against the turbine blades causing the wheel to rotate. This in turn rotates the shaft that is connected to the compressor and may be also connected to load equipment such as an electric generator or a gearbox. Thus, the turbine extracts energy from the hot gases to drive the compressor and provide useful work such as generating electricity or propelling an aircraft in flight.

It is well known that the efficiency of gas turbine engines can be increased by raising the turbine operating temperature. As operating temperatures are increased, the thermal limits of certain engine components, such as the turbine buckets, may be exceeded, resulting in reduced service life or even material failure. In addition, the increased thermal expansion and contraction of these components adversely affects clearances and their interfitting relationship with other components. Thus, it is desirable to monitor the temperature of turbine buckets during engine operation to assure that they do not exceed their maximum rated temperature for an appreciable period of time.

A common approach to monitoring turbine blade temperature is to measure the temperature of the gas leaving the turbine and to use this as an indication of the bucket temperature. The turbine exit temperature can be measured by locating one or more temperature sensors, such as thermocouples, in the exhaust stream. Because the blade temperature is measured indirectly, it is relatively inaccurate. Thus, it does not permit optimum blade temperatures to be utilized because a wide safety margin must be maintained.

The drawbacks of indirect blade temperature measurement are well known, and approaches for measuring, blade temperatures directly have been proposed. One direct measurement approach uses a radiation pyrometer located outside of the engine casing and having a field of view focused on the turbine buckets through a sight glass formed in the casing wall. Radiation emitted by the heated turbine buckets thus impinges on the pyrometer that then generates an electrical signal representative of the bucket temperature. However, during engine operation the sight glass is exposed to high temperature exhaust gases that tend to cloud the sight glass and adversely affect the pyrometer reading. Furthermore, the optical emissivity of the bucket surfaces is usually unknown, which also introduces error into the temperature measurement.

Accordingly, it would be desirable to have an approach to monitoring turbine blade temperature that remotely monitors blade temperature through the available sight glass, while avoiding the problems of limited optical access, impaired sight glasses, and unknown surface characteristics.

### BRIEF DESCRIPTION

In accordance with an embodiment of the invention, a thermal measurement system is provided. The thermal measurement system includes an array of detectors in two dimensions configured to receive radiation within multiple wavelength ranges, wherein the detectors have a first axis representing spatial dimension and a second axis representing a wavelength dimension. The system also includes an optical system configured to focus the radiation emitted by the object on to the array of detectors.

In accordance with another embodiment of the invention, a thermal measurement system for an object is provided. The thermal measurement system includes an array of detectors in two dimensions configured to receive radiation within a plurality of wavelength ranges, wherein the detectors have a first axis representing a spatial dimension and a second axis representing a wavelength dimension. The thermal measurement system also includes an optical system configured to focus radiation from the object onto each of the detectors. The thermal measurement system also includes a yawing and traversing system having a motor, wherein the motor is configured to rotate the optical system about an axis such that a desirable field of view is obtained creating a two dimensional map within the array of detectors.

In accordance with yet another embodiment of the invention, a method for manufacturing a thermal measurement system for an object is provided. The method includes providing an array of detectors in two dimensions configured to receive radiation within a plurality of wavelength ranges, wherein the array of detectors have a first axis representing a spatial dimension and a second axis representing a wavelength dimension. The method also includes providing an optical system configured to focus the radiation emitted by the object on to the array of detectors.

### DRAWINGS

These and other features, aspects, and advantages of the present invention will become better understood when the following detailed description is read with reference to the accompanying drawings in which like characters represent like parts throughout the drawings, wherein:

FIG. 1 is a schematic illustration of an exemplary gas turbine engine employing a thermal measurement system in accordance with an embodiment of the invention;

FIG. 2 is a magnified cross-sectional view of the gas turbine engine in FIG. 1 employing the thermal measurement system;

FIG. 3 is a schematic illustration of an exemplary optics system employed in the thermal measurement system in FIG. 1;

FIG. 4 is a schematic illustration of operation of the thermal measurement system on high pressure turbine blades;

FIG. 5 is a graphical comparison of absolute temperature measurements performed by multi-color and single color techniques; and

FIG. 6 is a flow chart representing steps in an exemplary method for manufacturing a thermal measurement system.

### DETAILED DESCRIPTION

As discussed in detail below, embodiments of the invention include a system and method for thermal inspection of objects. The system and method disclosed herein employ a detection system that detects radiation at multiple wavelengths along one axis, while a spatial component in a perpendicular axis to achieve an accurate measurement of temperature of components during operation. The radiation obtained is further fit into a multi-spectral or multi-wavelength algorithm based on Planck's law to generate absolute temperature and apparent emissivity. As used herein, the term ‘objects’ refers to, but is not limited to, turbine blades. Although many of the examples discussed below involve rotating objects, the system is equally applicable to both stationary and rotating objects.

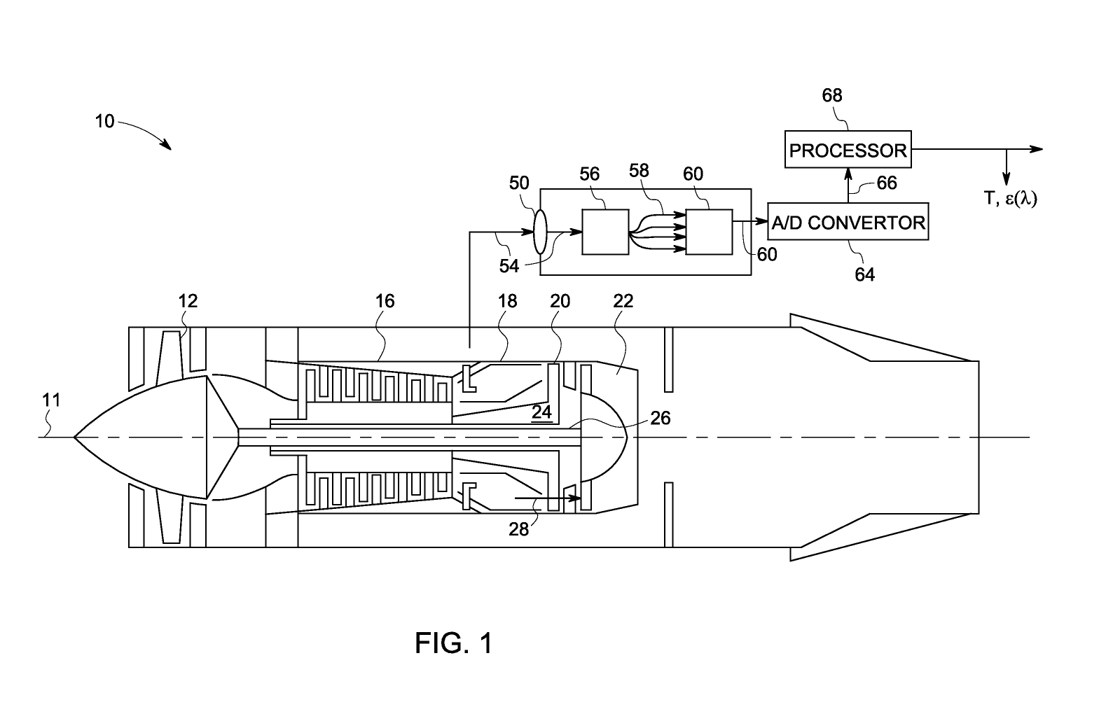

Turning to the drawings, FIG. 1 is an exemplary gas turbine engine 10 circumferentially disposed about an engine centerline 11 and in serial flow relationship a fan section reference by numeral 12, a high pressure compressor 16, a combustion section 18, a high pressure turbine 20, and a low pressure turbine 22. The combustion section 18, the high pressure turbine 20, and low pressure turbine 22 are often referred to as the hot section of the engine 10. A high pressure rotor shaft 24 connects, in driving relationship, the high pressure turbine 20 to the high pressure compressor 16 and a low pressure rotor shaft 26 drivingly connects the low pressure turbine 22 to the fan section 12. Fuel is burned in the combustion section 18 producing a very hot gas flow 28 that is directed through the high pressure and low pressure turbines 20 and 22 respectively to power the engine 10. An optical system 50 is coupled to the gas turbine engine 10. The optical system 50 directs radiation beam 54 emitted in a field of view including a part of the gas turbine engine 10, for example, blades of the high pressure turbine 20. In a particular embodiment, the optical system 50 includes an assembly of lenses and mirrors, or a fiber optic cable.

The radiation beam 54 is further incident upon a detector system 56. The detector system 56 splits the radiation beam 54 into beams 58 of different wavelengths. The beams 58 are further incident upon multiple detectors 60 that generate an output signal 62 representative of the beams 58. The output signal 62 is transmitted to an analog-to digital converter 64 that digitizes the signal 62, resulting in a digital signal 66. The digital signal 66 is further input into a processor 68 that computes an apparent emissivity spectrum and a corresponding temperature.

It should be noted that the present invention is not limited to any particular processor for performing the processing tasks of the invention. The term “processor,” as that term is used herein, is intended to denote any machine capable of performing the calculations, or computations, necessary to perform the tasks of the invention. The term “processor” is intended to denote any machine that is capable of accepting a structured input and of processing the input in accordance with prescribed rules to produce an output. It should also be noted that the phrase “configured to” as used herein means that the processor is equipped with a combination of hardware and software for performing the tasks of the invention, as will be understood by those skilled in the art.

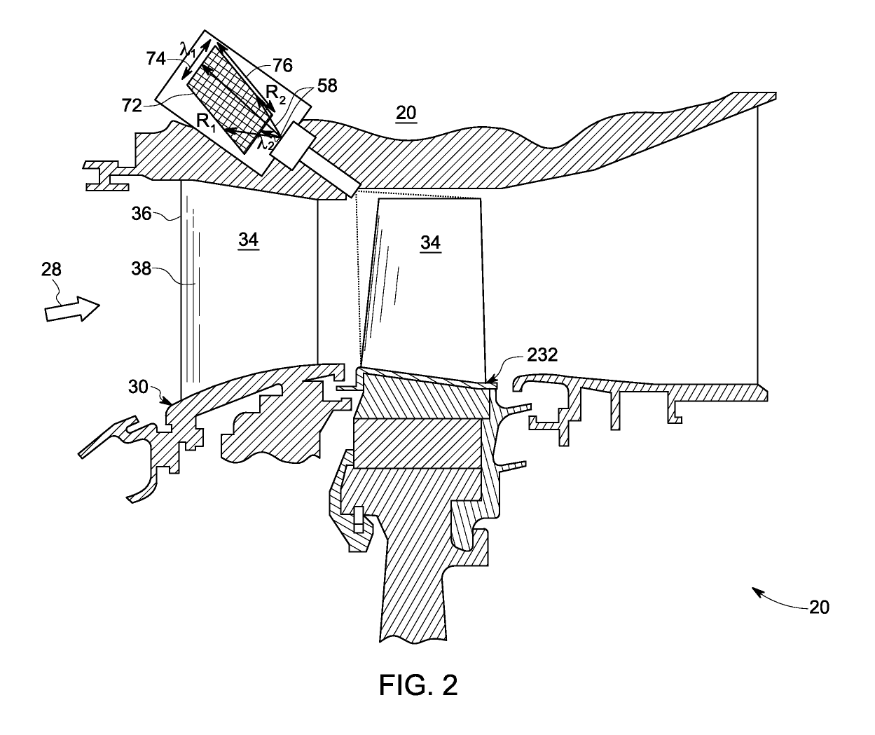

FIG. 2 illustrates a magnified cross-sectional view of the high pressure turbine 20 in FIG. 1 having a turbine vane 30 and a turbine blade 32. An exemplary airfoil 34 may be used for either or both the turbine vane 30 and the turbine blade 32. The airfoil 34 has an outer wall 36 with a hot wetted surface 38 that is exposed to the hot gas flow 28. Turbine vanes 30, and in many cases turbine blades 32, are often cooled by air routed from the fan or one or more stages of the compressors. The optical system 50 is mounted to the engine 10 such that an entire area of the airfoil 34 is covered within an optical field of view 71. The beams 58, as referenced in FIG. 1, of different wavelengths are incident upon an array of detectors 72 in 2D. The detector array 72 includes a spatial component along one axis 74 and a spectral wavelength component along another axis 76. In the illustrative embodiment, the spatial component varies from R₁ to about R₂, while the wavelength varies from λ₁ to about λ₂. In a particular embodiment, a yawing and traversing system having a motor, rotates the optical system 50 about an axis such that a desirable optical field of view 71 is obtained creating a two dimensional map within the array of detectors 72. In another embodiment, the field of view 71 is traversed from an initial position for a static object.

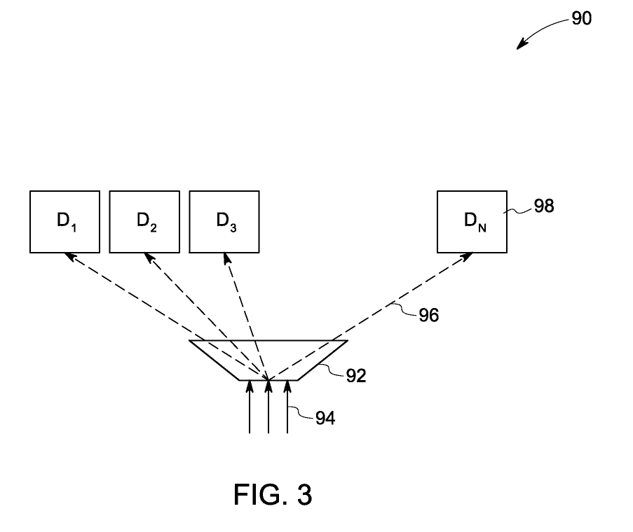

FIG. 3 is a schematic illustration of an exemplary optics system 90. The optics system 90 includes a grating 92 that splits a radiation beam 94 received from an object (not shown) into beams 96 of different wavelengths. The beams 96 are incident upon multiple detectors 98 that output signals 100 representative of the different wavelengths. Each of the detectors 98 is a two dimensional array of detectors including a spatial component along an axis and a wavelength component along a perpendicular axis. In an exemplary embodiment, the detectors 98 include multiple filters to selectively filter the radiation received. In another embodiment, the detectors 98 receive radiation within a wavelength range of about 0.6 micrometers and greater where gas absorption is not significant.

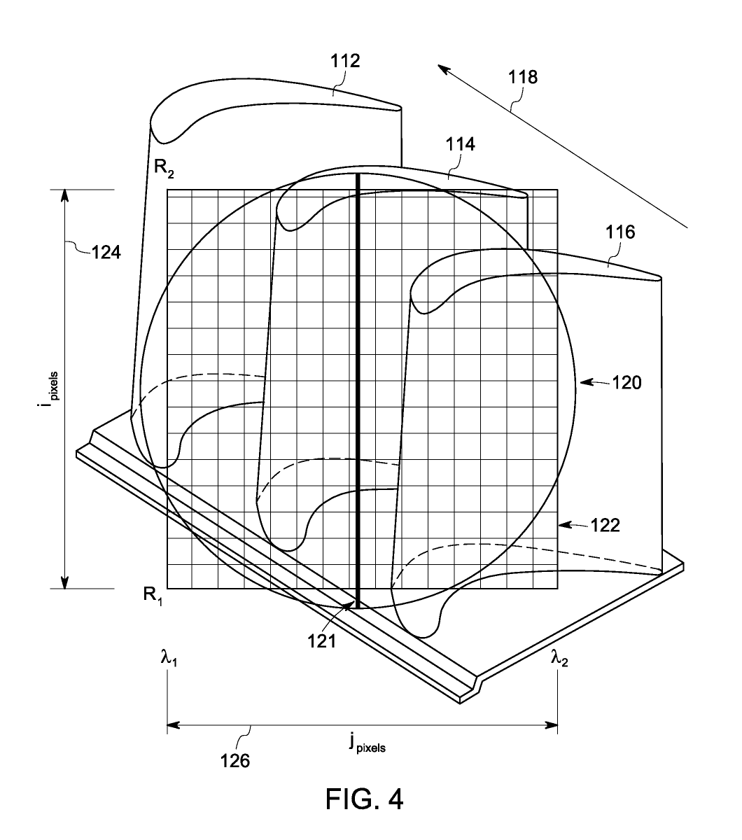

FIG. 4 is a schematic illustration of an operation of the detection system including two-dimensional mapping on a turbine system. In the illustrated embodiment, blades 112, 114, and 116 are rotating in a direction 118 inside of a plane of paper. It should be noted that more than three blades may also be employed. An optical system (not shown) is aligned such that the blades 112, 114 and 116 are within an optical field of view 120. During a revolution of the blades 112, 114, and 116, signal acquisition occurs at a certain instant of time, at multiple spots along a plane 121 of the field of view 120, for each of the blades. A two-dimensional map 122 is formed within the optical field of view 120. A spatial information of the blades 112, 114 and 116 is collected along an axis 124, while a spectral information is collected along an axis 126 perpendicular to the axis 124. In the illustrated embodiment, the axis 124 is divided into pixels that include information about the spatial component ranging from R₁ to R₂, and the axis 126 is divided into pixels that include information pertaining to the wavelength ranging from about λ₁ to about λ₂. In one embodiment, the detector is sampled such that all the blades are sampled in one revolution. In a non-limiting example, the detector is sampled at 1 MHz. In a particular embodiment, signal acquisition is performed via strobing. In another embodiment, sampled data is phase locked. A spectral signal obtained from the detectors is further input into the processor (FIG. 1) to calculate apparent emissivity and absolute temperature of the blades. In a particular embodiment, the spectral signal is input into a Planck's law fitting routine to calculate the emissivity and the absolute temperature.

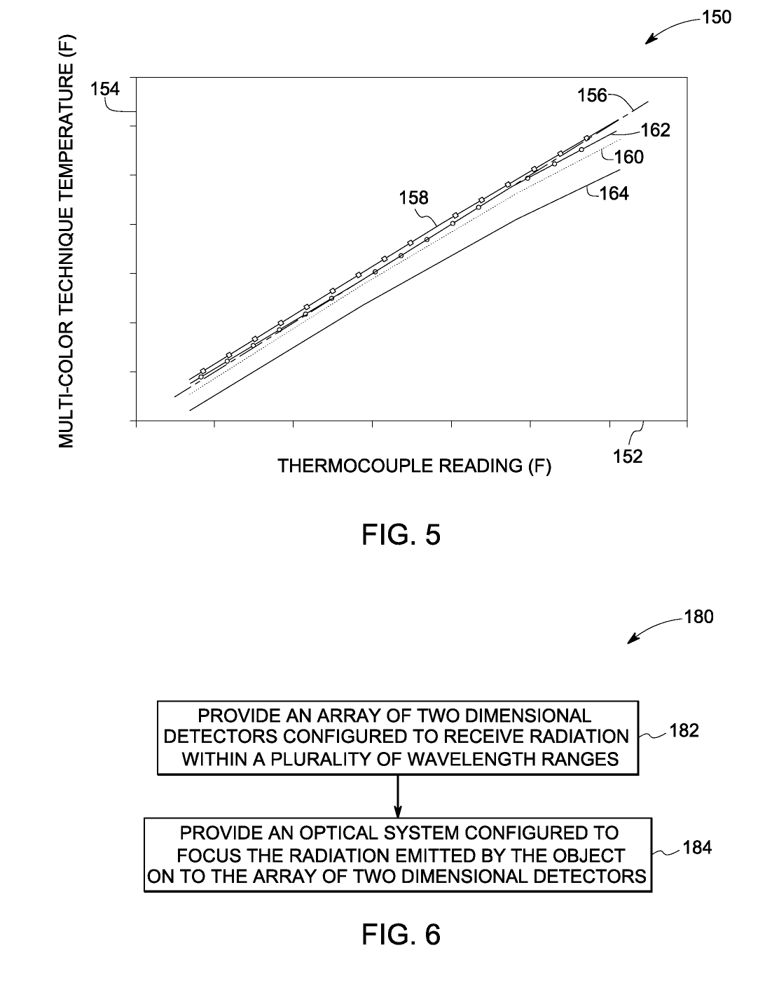

FIG. 5 is a graphical comparison 150 of absolute temperature measured by multi-color and single color techniques. The X-axis 152 represents a thermocouple reading in ° F, while the Y-axis 154 represents temperature measured by a multi-color or a single color technique. A curve 156 indicates a baseline measurement using a thermocouple. Curve 158 represents a temperature measurement made by a multi-color technique with an optimal optical path and curve 160 represents a temperature measurement made by a multi-color technique with a degraded optical path. As used herein, the term ‘degraded’ refers to a change in the optical system such as a cloudy field of view due to harsh environmental conditions. As illustrated, the curve 160 indicates an accurate temperature measurement in presence of harsh environmental conditions, thus showing robustness within target uncertainty. Similarly, curves 162 and 164 indicate temperature measured employing a single color technique with an optimal optical path (and known target radiative properties) and a degraded optical path respectively. The single color technique also employs an assumed emissivity. Curve 164 indicates a significant error in temperature measurement in a degraded optical path, thus rendering it undesirable in harsh environmental conditions.

FIG. 6 is a flow chart representing steps in an exemplary method 180 for manufacturing a thermal measurement system for an object. The method 180 includes providing an array of detectors in two dimensions configured to receive radiation within multiple wavelength ranges in step 182, wherein the array of detectors have a first axis representing a spatial dimension and a second axis representing a wavelength dimension. An optical system is provided in step 184 such that to focus the radiation emitted by the object on to the array of two-dimensional detectors.

The various embodiments of a system and method for thermal inspection described above thus provide a high-speed, online, non-intrusive, multi-color, full-field detection to accurately measure an absolute temperature of the object during operation. These techniques and systems also allow for online detection of thermal radiation at multiple wavelengths for temperature and apparent emissivity measurement. Furthermore, online computation of temperature allows for monitoring of film hole blockages, local and overall variations or changes in component thermal performance, providing part-to-part temperature variation data, and thermal performance history from time of installation to the end of service. Additionally, the technique provides higher quality turbine reliability and operability thus protecting contractual service agreements and providing improved in operator flexibility and machine operability. Online thermal measurements coupled with latest real-time turbine diagnosis, cumulative damage enables higher and improved individual component and overall machine life.

Of course, it is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

Furthermore, the skilled artisan will recognize the interchangeability of various features from different embodiments. For example, the use of an indium-gallium-arsenide based detector described with respect to one embodiment can be adapted for use with a stationary object described with respect to another. Similarly, the various features described, as well as other known equivalents for each feature, can be mixed and matched by one of ordinary skill in this art to construct additional systems and techniques in accordance with principles of this disclosure.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A thermal measurement system for an object comprising:
an array of detectors in two dimensions configured to receive radiation within a plurality of wavelength ranges, the detectors having a first axis representing a spatial dimension and a second axis representing a wavelength dimension; and
an optical system configured to focus the radiation emitted by the object on to the array of detectors.

2. The thermal measurement system of claim 1, wherein the detectors are configured to receive radiation within a wavelength range of about 0.6 micrometers and greater.

3. The thermal measurement system of claim 1, wherein the detectors comprises three or more detectors.

4. The thermal measurement system of claim 1, wherein the detectors are selected from the group consisting of indium-gallium-arsenide based detectors, silicon based detectors, extended indium-gallium-arsenide based detectors and lead-antimony based detectors.

5. The thermal measurement system of claim 1, wherein the optical system comprises a fiber optic cable or an assembly of lenses and mirrors.

6. The thermal measuring system of claim 1, further comprising an analog-to-digital signal converter configured to convert an analog signal from each of the detectors to a digital signal.

7. The thermal measurement system of claim 1, further comprising a processor configured to receive a plurality of signals from the detectors, and output a temperature profile of the object and emissivity data based on the signals.

8. The thermal measurement system of claim 1, further comprising a plurality of filters configured to selectively filter the radiation received by the detectors.

9. The thermal measurement system of claim 1, wherein the object is a static object or a rotating object.

10. The thermal measurement system of claim 9, wherein the rotating object comprises a gas turbine blade.

11. The thermal measurement system of claim 9, configured to sample radiation at a plurality of spots on the rotating object during a revolution of the object.

12. A thermal measurement system for an object comprising:
an array of detectors in two dimensions configured to receive radiation within a plurality of wavelength ranges, the array of detectors having a first axis representing a spatial dimension and a second axis representing a wavelength dimension;
an optical system configured to focus radiation from the object onto each of the array of detectors; and
a yawing and traversing system comprising a motor, the motor configured to rotate the optical system about an axis such that a desirable field of view is obtained creating a two dimensional map within the array of detectors.

13. The thermal measurement system of claim 12, wherein the detectors are configured to receive radiation within the wavelength range of about 0.6 micrometers and greater.

14. The thermal measurement system of claim 12, wherein the array of detectors comprise three or more detectors.

15. The thermal measurement system of claim 12, wherein the detectors are selected from the group consisting of indium-gallium-arsenide based detectors, silicon based detectors, extended indium-gallium-arsenide based detectors and lead-antimony based detectors.

16. The thermal measurement system of claim 12, wherein the optical system comprises a fiber optic cable or an assembly of lenses and mirrors.

17. The thermal measurment system of claim 12, further comprising an analog to digital signal conditioner configured to convert an analog signal from each of the detectors to a digital signal.

18. The thermal measurement system of claim 12, further comprising a processor configured to receive intensity data from each of the detectors, and determine a temperature profile of the object based on the intensity data.

19. The thermal measurement system of claim 12, further comprising a plurality of filters configured to selectively filter the radiation received by the detectors.

20. The thermal measurement system of claim 12, wherein the object is a rotating object.

21. The thermal measurement system of claim 20, wherein the rotating object comprises a gas turbine blade.

22. The thermal measurement system of claim 20, configured to sample radiation at a plurality of spots on the rotating object during a revolution of the object.

23. A method for manufacturing a thermal measurement system for an object comprising:
providing an array of detectors in two dimensions configured to receive radiation within a plurality of wavelength ranges, the array of detectors having a first axis representing a spatial dimension and a second axis representing a wavelength dimension; and
providing an optical system configured to focus the radiation emitted by the object on to the array of detectors.
